(19) United States
(12) Patent Application Publication
(10) Pub. No.: US 2017/0085958 A1
(43) Pub. Date: Mar. 23, 2017

(54) ELECTRONIC DEVICE AND OPERATING METHOD OF THE SAME

(71) Applicant: SAMSUNG ELECTRONICS CO., LTD., Suwon-si (KR)

(72) Inventor: Sang-ha CHOI, Seoul (KR)

(21) Appl. No.: 15/218,236

(22) Filed: Jul. 25, 2016

(30) Foreign Application Priority Data
Sep. 21, 2015 (KR) 10-2015-0133089

(51) Int. Cl. H04N 21/482; H04N 21/2343; H04N 21/438; H04N 21/41; H04N 21/84

(52) U.S. Cl. CPC H04N 21/4821; H04N 21/4126; H04N 21/84; H04N 21/438; H04N 21/2343

(57) ABSTRACT

An electronic device and a method of operating the same are disclosed. The electronic device includes a receiver configured to receive a broadcast signal, and a controller configured to obtain program information from the broadcast signal, the program information comprising information on a plurality of programs, the information on each program comprising a program identifier and a compression format into which a stream corresponding to the program is compressed; determine whether the compression format of the program is processable by the electronic device; and generate a program map including the program identifier corresponding to the program having the compression format being processable by the electronic device, and excluding the program identifier corresponding the program having the compression format not being processable by the electronic device.

### CROSS-REFERENCE TO RELATED APPLICATION

This application is based on and claims priority under 35 U.S.C. §119 to Korean Patent Application No. 10-2015-0133089, filed on Sep. 21, 2015, in the Korean Intellectual Property Office, the disclosure of which is incorporated by reference herein in its entirety.

### BACKGROUND

1. Field

The present disclosure relates to an electronic device for providing program information and an operating method of the electronic device.

2. Description of Related Art

A display device has a function of displaying a video viewable by a user. The user may view a broadcast through the display device. The display device displays a broadcast selected by the user on a display among broadcast signals transmitted by broadcasting stations. There is a current trend of switching from analog broadcasting to digital broadcasting all over the world.

Digital broadcasting represents broadcasting that transmits digital video and voice signals. Compared to analog broadcasting, digital broadcasting results in less data loss due to robustness to noise, facilitates error correction, shows high resolution, and provides a clear screen. Also, digital broadcasting enables a bidirectional service.

Meanwhile, a broadcast receiver checks characteristics of a channel from a received broadcast signal, and builds a channel map by adding the channel to the channel map. However, in practice, even channels having streams not processable by the receiver may be added to the channel map and selected from the channel list. Such channels are not decoded, and thus it is necessary to display a message such as “Service Not Available.” Therefore, an existing broadcast receiver displays information on channels including ones which may not be provided to the user on a channel list, and the user may unknowingly attempt to select the channels. Also, even during channel zapping, such a channel is not skipped but is passed through. These may cause an inconvenience for the user.

### SUMMARY

An electronic device capable of providing only information on channels processable by a broadcast receiver to a user, and an operating method of the electronic device are provided.

Additional aspects will be set forth in part in the description which follows and, in part, will be apparent from the description.

According to an aspect of an example embodiment, an electronic device includes a receiver configured to receive a broadcast signal, and a controller configured to obtain program information from the broadcast signal, the program information comprising information on a plurality of programs, the information on each program comprising a program identifier and a compression format into which a stream corresponding to the program is compressed; determine whether the compression format of the program is processable by the electronic device; and generate a program map including the program identifier corresponding to the program having the compression format being processable by the electronic device, and excluding the program identifier corresponding the program having the compression format not being processable by the electronic device.

The controller may be configured to control a display to display the generated program map.

According to an aspect of another example embodiment, a method of operating an electronic device includes receiving a broadcast signal, obtaining program information from the broadcast signal, the program information comprising information on a plurality of programs, the information on each program comprising a program identifier and a compression format into which a stream corresponding to the program is compressed; determining whether the compression format of the program is processable by the electronic device; and generating a program map including the program identifier corresponding to the program having the compression format being processable by the electronic device, and excluding the program identifier corresponding the program having the compression format not being processable by the electronic device.

The method may include displaying the generated program map on a display.

According to an aspect of still another example embodiment, a non-transitory computer-readable recording medium stores a program for causing a computer to perform an operating method including receiving a broadcast signal, obtaining program information from the broadcast signal, the program information comprising information on a plurality of programs, the information on each program comprising a program identifier and a compression format into which a stream corresponding to the program is compressed; determining whether the compression format of the program is processable by the electronic device; and generating a program map including the program identifier corresponding to the program having the compression format being processable by the electronic device, and excluding the program identifier corresponding the program having the compression format not being processable by the electronic device.

### BRIEF DESCRIPTION OF THE DRAWINGS

These and/or other aspects will become apparent and more readily appreciated from the following detailed description, taken in conjunction with the accompanying drawings, in which like reference numerals refer to like elements, and wherein:

FIG. 1 is a diagram illustrating an example method of building a channel map;

FIG. 2 is a block diagram illustrating an example electronic device;

FIG. 3 is a block diagram illustrating an example configuration of the electronic device shown in FIG. 2;

FIG. 4 is a diagram illustrating an example of a storage shown in FIG. 3;

FIG. 5 is a diagram illustrating an example of a transport stream received by a tuner of the electronic device;

FIG. 6 is a table illustrating an example of elementary stream types;

FIG. 7 is a flowchart illustrating an example of an operation performed by the electronic device; and

FIGS. 8 and 9 are diagrams illustrating an example operation of the present disclosure in comparison with an existing operation example.

### DETAILED DESCRIPTION

Hereinafter, various example embodiments will be described in greater detail with reference to the accompanying drawings. While the present disclosure may be embodied in many different forms, example embodiments of the present disclosure are illustrated in the drawings and are described herein in greater detail, with the understanding that the example embodiments of the present disclosure are to be considered as an exemplification of the principles of the disclosure and is not intended to limit the disclosure to the particular example embodiments illustrated. It is therefore intended that the disclosure be interpreted to include all variations and equivalents that fall within the spirit and scope of the present disclosure. The same reference numbers are used throughout the drawings to refer to the same or like elements. Expressions such as “at least one of,” when preceding a list of elements, modify the entire list of elements and do not modify the individual elements of the list.

The expression “include” or “may include” used in various example embodiments of the present disclosure indicates presence of a disclosed function, operation, or element and does not limit at least one additional function, operation, or element. Further, in various example embodiments of the present disclosure, the term “include” or “have” indicates presence of a characteristic, numeral, step, operation, element, part, or combination thereof described in the description and does not exclude presence or addition of at least one other characteristic, numeral, step, operation, element, part, or combination thereof.

In the present disclosure, the expression “or” includes any combination or the entire combination of words listed together. For example, “A or B” may include A, B, or A and B.

The expressions “first,” “second,” “primary,” and “secondary” used in various example embodiments of the present disclosure may represent various elements of various example embodiments of the present disclosure, but do not limit corresponding elements. For example, the expressions do not limit order and/or importance of corresponding elements. The expressions may be used for distinguishing one element from another element. For example, both a first user device and a second user device are user devices and represent different user devices. For example, a first element may be referred to as a second element without deviating from the scope of various example embodiments of the present disclosure, and similarly, a second element may be referred to as a first element.

When it is described that an element is “coupled” or “connected” to another element, the element may be directly coupled or connected to the other element, or may be coupled or connected to the other element through still another element. However, when it is described that an element is “directly coupled” or “directly connected” to another element, no element may be interposed between the element and the other element.

Terms used in various example embodiments of the present disclosure are not to limit various example embodiments of the present disclosure but to illustrate particular example embodiments. A singular expression includes a plural expression unless clearly indicated otherwise in context.

Unless defined otherwise, all terms including technical terms and scientific terms used herein have the same meaning as a meaning that may be generally understood by those of ordinary skill in the art. It is to be understood that terms defined in a generally used dictionary have a meaning corresponding to that of the context of related technology and are not interpreted as an ideal or excessively formal meaning unless clearly defined in various example embodiments of the present disclosure.

Hereinafter, an electronic device according to various example embodiments will be described with reference to the accompanying drawings. The term “user” used in various example embodiments may indicate a person who uses the electronic device or a device (e.g., artificial intelligence electronic device) which uses the electronic device.

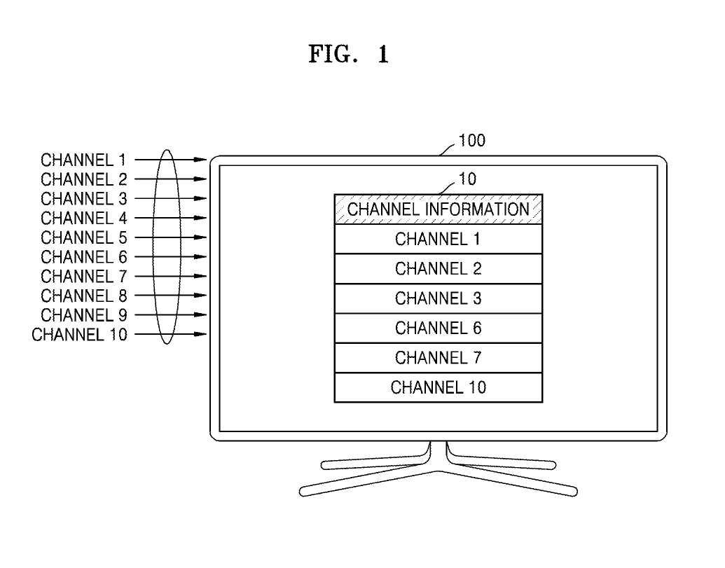

FIG. 1 is a diagram illustrating an example method of building a channel map.

Referring to FIG. 1, an electronic device 100 may receive a broadcast signal containing information on a plurality of channels.

The broadcast signal includes information on the plurality of channels and streams corresponding to the respective channels. The electronic device 100 parses the information on the plurality of channels included in the broadcast signal to build a channel map, and provides information on the channel map through a display of the electronic device 100. A user may perform a channel search through the channel map displayed on the display and select a channel.

The broadcast signal may include all of streams whose data is processable by the electronic device 100 and streams whose data is not processable by the electronic device 100. When the electronic device 100 builds the channel map by including channel information of the streams whose data is not processable in the channel map, the user may search and select channels which are included in the channel map and provide the streams whose data are not processable by the electronic device 100, and thus a user may be inconvenienced by, for example, attempting to select channels that are not processable.

Accordingly, the electronic device 100 according to an example embodiment builds a channel map excluding channel information corresponding to the streams whose data is not processable by the electronic device 100 from the received broadcast signal, so that a channel map including only channel information corresponding to the streams whose data is processable by the electronic device 100 may be provided to the user. By excluding the channel information corresponding to the streams whose data is not processable by the electronic device 100 from the channel map provided to the user, it is possible to prevent the user from selecting an unavailable channel from the channel map displayed on the display.

Referring to FIG. 1, the electronic device 100 receives a broadcast signal including streams corresponding, for example, to channel 1 to channel 10. The electronic device 100 may parse the received broadcast signal to build a channel map not including channels corresponding to streams whose data is not processable by the electronic device 100, for example, channels 4, 5, 8, and 9, but including only channels corresponding to streams whose data is processable by the electronic device 100, for example, channels 1, 2, 3, 6, 7, and 10, and may provide channel information 10 based on such a channel map.

In this description, a stream whose data is processable by the electronic device 100 may be expressed in various ways, such as a stream supported by the electronic device 100, a stream compatible with the electronic device 100, a stream in accordance with specifications of the electronic device 100, a stream having a compression format into which a stream corresponding to the program is compressed, which is processable by the electronic device 100, and so on.

Likewise, a stream whose data is not processable by the electronic device 100 may be expressed in various ways, such as a stream unsupported by the electronic device 100, a stream incompatible with the electronic device 100, a stream out of accordance with specifications of the electronic device 100, a stream having a compression format into which a stream corresponding to the program is compressed, which is not processable by the electronic device 100, and so on.

Also, in this description, the term “channel” may be expressed as a program or service.

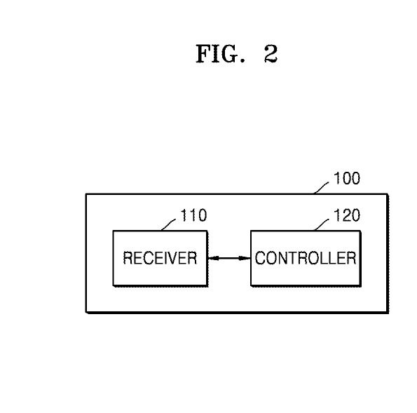

FIG. 2 is a block diagram illustrating an example of the electronic device 100.

Referring to FIG. 2, the electronic device 100 includes a receiver 110 and a controller (e.g., including processing circuitry, such as, for example, a CPU or the like) 120.

The receiver 110 includes circuitry configured to receive a broadcast signal transmitted from a broadcasting station. The broadcast signal may include metadata of one or more programs, and audio streams and video streams corresponding to the respective programs. The metadata of each program includes a stream type of an audio stream or a video stream corresponding to the program.

The controller 120 may be configured to control components throughout the electronic device 100 including the receiver 110. The controller 120 may include a RAM which stores a signal input from the outside of the electronic device 100 or is used as a storage area corresponding to various tasks performed by the electronic device 100, a ROM in which a control program for controlling peripheral devices, and a processor. The processor may be implemented as a system on chip (SoC) in which a core (not shown) and a graphics processing unit (GPU) are integrated. Also, the processor may include a plurality of processors and/or various processing circuitry.

According to an example embodiment, the controller 120 may be configured to parse the metadata of a program to detect a stream type, and to determine whether the detected stream type is processable by the electronic device 100. When it is determined that the stream type is processable by the electronic device 100, the controller 120 is configured to add the program providing the corresponding stream to a program map. On the other hand, when it is determined that the stream type is not processable by the electronic device 100, the controller 120 is configured to not add the program providing the corresponding stream to the program map. In this way, the controller 120 may be configured to build the program map with programs which provide streams corresponding to stream types processable by the electronic device 100.

The electronic device 100 illustrated in FIG. 2 may, for example, be a television (TV) which generally receives a broadcast signal. However, the electronic device 100 is not limited to a TV and may be any device capable of receiving and processing a broadcast signal. For example, the electronic device 100 may be various TVs, a set-top box, a smart phone, a tablet PC, a laptop PC, a wearable device, and so on.

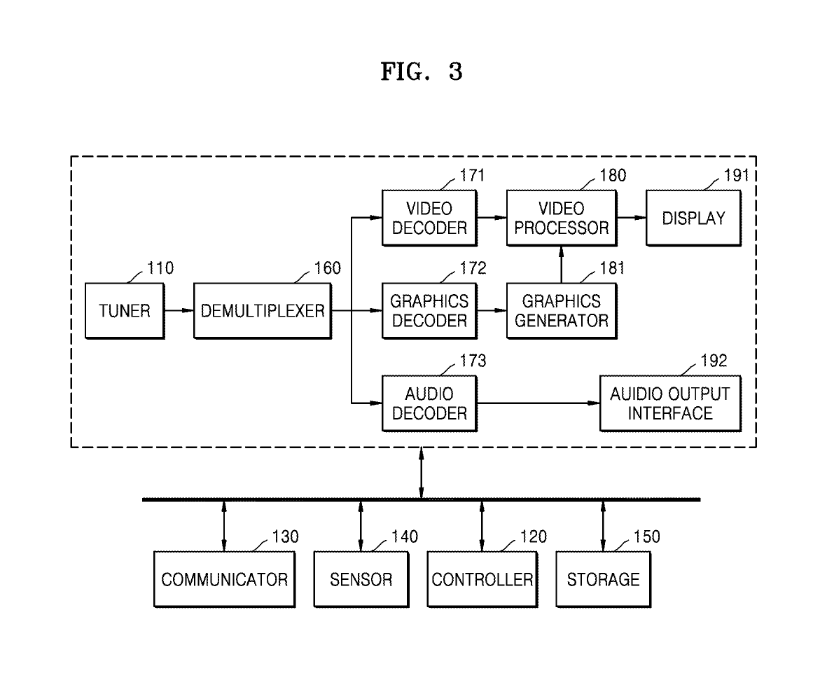

FIG. 3 is a diagram illustrating an example configuration of the electronic device 100 shown in FIG. 2.

Referring to FIG. 3, the electronic device 100 includes a tuner 110, a controller (e.g., including processing circuitry, such as, for example, a CPU or the like) 120, a communicator (e.g., including communication circuitry) 130, a sensor (that may include plural sensor or sensing circuitry) 140, a storage (e.g., a memory) 150, a demultiplexer 160, a video decoder 171, a graphics decoder 172, an audio decoder 173, a video processor 180, a display 191, a graphics generator 181, and an audio output interface 192.

The tuner 110 processes a TV broadcast signal input, for example, to an antenna terminal (not shown) which inputs the TV broadcast signal received through an antenna, and outputs a transport stream (bit stream data) corresponding to a channel selected by the user.

The tuner 110 may process a broadcast signal received in a wired or wireless manner through amplification, mixing, resonance, etc., and tune and select only a frequency of a channel that the electronic device 100 intends to receive from among many received radio wave components. The broadcast signal includes audio, video, and additional information (e.g., an electronic program guide (EPG)).

The tuner 110 may receive a broadcast signal in a frequency band corresponding to a channel number (e.g., a cable broadcasting number of 506) based on an input (e.g., a control signal received from a control device, that is, an input of a channel number, a channel up-down input, or a channel input in an EPG screen).

The tuner 110 may receive broadcast signals from various sources, such as a terrestrial broadcast, a cable broadcast, a satellite broadcast, an Internet broadcast, and so on. The tuner 110 may also receive a broadcast signal from a source, such as an analog broadcast, a digital broadcast, or so on.

The tuner 110 of the electronic device 100 may be single or plural in number. The tuner 110 may be implemented as one body (i.e., all-in-one) with the electronic device 100, as a separate device (e.g., a set-top box; not shown) having a tuner electrically connected to the electronic device 100, or as a tuner (not shown) connected to a separate input/output interface.

The demultiplexer 160 extracts each of video, graphics, and audio elementary streams from the transport stream output from the tuner 110. The demultiplexer 160 may also extract metadata of each elementary stream from the transport stream and provide the metadata to the controller 120.

The video decoder 171 decodes encoded video data included in the video elementary stream extracted by the demultiplexer 160, thereby obtaining decoded video data.

The audio decoder 173 decodes encoded audio data included in the audio elementary stream extracted by the demultiplexer 160, thereby obtaining decoded audio data.

The graphics decoder 172 decodes encoded graphics data included in the graphics elementary stream, thereby obtaining decoded graphics data.

A graphics generator 181 generates data of graphics information superimposed on the video based on the graphics data obtained by the graphics decoder 172, and outputs the generated graphics data to the video processor 180.

The video processor 180 may be configured to perform various image processing, such as scaling, noise filtering, frame rate conversion, resolution conversion, etc., on the video data. Also, the video processor 180 superimposes the graphics data on the decoded video data and outputs the resultant data to the display 191.

The audio output interface 192 may include, for example, one or more of a speaker, a headphone output terminal, and a Sony/Philips digital interface (S/PDIF) output terminal. The audio output interface 192 may include a combination of the speaker, the headphone output terminal, and the S/PDIF output terminal.

The communicator 130 may connect the electronic device 100 to an external device (e.g., an audio device, etc.) under control of the controller 120. The communicator 130 may include one or a combination of communication circuitry, including, for example, a wireless local area network (WLAN) module, a Bluetooth module, and a wired Ethernet module in accordance with performance and the structure of the electronic device 100. The communicator 130 may receive a control signal of a control device under control of the controller 120. The control signal may be implemented as a Bluetooth type, a radio frequency (RF) signal type, or a wireless fidelity (Wi-Fi) type. In addition to the Bluetooth module, the communicator 130 may further include other short-range communication modules (e.g., a near field communication (NFC) module (not shown) and a Bluetooth low energy (BLE) module (not shown), or the like.

The controller 120 may be configured to control overall operation of the electronic device 100 and signal flow between internal components of the electronic device 100, and to process data. When there is an input or a condition which has been preset and stored is satisfied, the controller 120 may be configured to execute an operating system (OS) and various applications stored in the storage 150.

The controller 120 may include a processor. The controller 120 may further include a RAM which stores a signal or data input from the outside of the electronic device 100 or is used as a storage area corresponding to various tasks performed in the electronic device 100, or a ROM storing a control program for control of the electronic device 100.

The processor may include a CPU (not shown), a GPU (not shown) for processing graphics corresponding to a video. The processor may be implemented as an SoC in which a core (not shown) and the GPU (not shown) are integrated. Also, the processor may include a plurality of processors and/or various processing circuitry.

According to an example embodiment, the controller 120 may be configured to parse program information included in a broadcast signal and to build a program map excluding a program which provides a stream not processable by the electronic device 100.

According to an example embodiment, when there is a change of program information included in a broadcast signal, the controller 120 may be configured to parse the program information included in the broadcast signal and to build a program map excluding a program which provides a stream not processable by the electronic device 100.

According to an example embodiment, the controller 120 may be configured to output a program map including information on programs which provide streams processable by the electronic device 100 to the display 191.

The sensor 140 senses a voice, a video, or an interaction of the user. For example, the sensor 140 may include a microphone, a camera, a light receiver, and so on. The light receiver may receive an optical signal corresponding to a user input (e.g., a touch, a press, a touch gesture, voice, or a motion) from an external control device. A control signal may be extracted from the received optical signal under control of the controller 120.

The storage 150 may store various data, programs, or applications for operating and controlling the electronic device 100 under control of the controller 120. The storage 150 may store input and output signals or data corresponding to operation of the tuner 110, the communicator 130, the sensor 140, the storage 150, the demultiplexer 160, the video decoder 171, the graphics decoder 172, the audio decoder 173, the video processor 180, the display 191, and the audio output interface 192. The storage 150 may store a control program for control of the electronic device 100 and the controller 120, an application originally provided by a manufacturer or externally downloaded, a graphical user interface (GUI) related to the application, objects (e.g., image text, icons, buttons, etc.) for providing the GUI, user information, documents, databases (DBs), or related data.

In an example embodiment, the term “storage” includes the storage 150, the ROM and the RAM of the controller 120, or a memory card (e.g., a micro secure digital (SD) card or a universal serial bus (USB) memory (not shown)) installed in the electronic device 100. The storage 150 may also include, for example, a non-volatile memory, a volatile memory, a hard disk drive (HDD), or a solid-state drive (SSD).

At least one of the components illustrated in the electronic device 100 of FIG. 3 may be added or omitted based on performance of the electronic device 100. Those of ordinary skill in the art will readily appreciate that locations of the components may be changed based on performance or the structure of the electronic device 100.

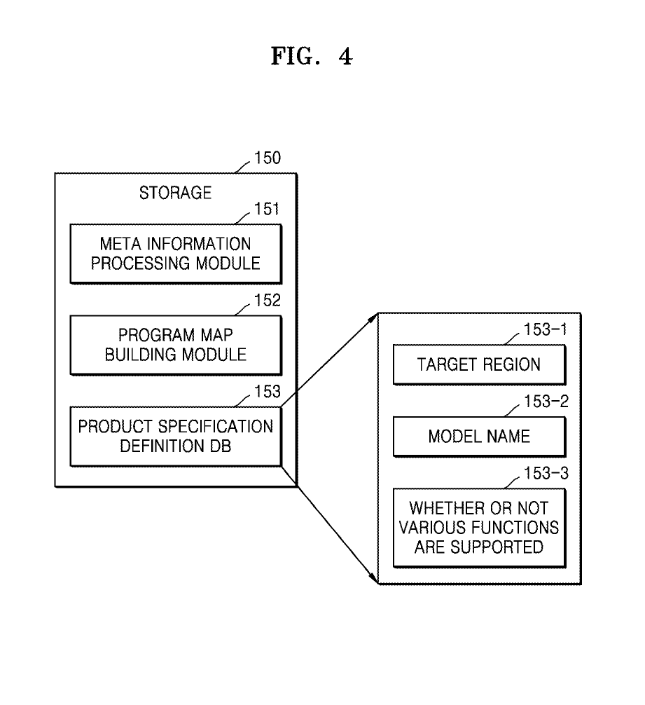

FIG. 4 is a diagram illustrating an example of a storage shown in FIG. 3.

Referring to FIG. 4, the storage 150 may include a meta information processing module 151, a program map building module 152, and a product specification definition DB 153.

The meta information processing module 151 may include, for example, one or more instructions for collecting metadata included in a broadcast signal and processing configuration information of programs.

The program map building module 152 may include, for example, one or more instructions for building a program map using the configuration information of the programs.

According to an example embodiment, the program map building module 152 may include, for example, one or more instructions for determining whether the corresponding stream type is processable by the electronic device 100 based on stream type information extracted from meta information included in the broadcast signal and product specifications stored in the product specification definition DB 153.

According to an example embodiment, the program map building module 152 may also include one or more instructions for building a program map not by including information on programs whose stream types are not processable by the electronic device 100 but by only including information on programs whose stream types are processable by the electronic device 100 in the program map.

The product specification definition DB 153 is a DB for defining product specifications of the electronic device 100.

Data stored in the product specification definition DB 153 may include a target region 153-1 representing information on country or region-specific broadcast specifications, a model name 153-2, and whether or not various functions are supported 153-3.

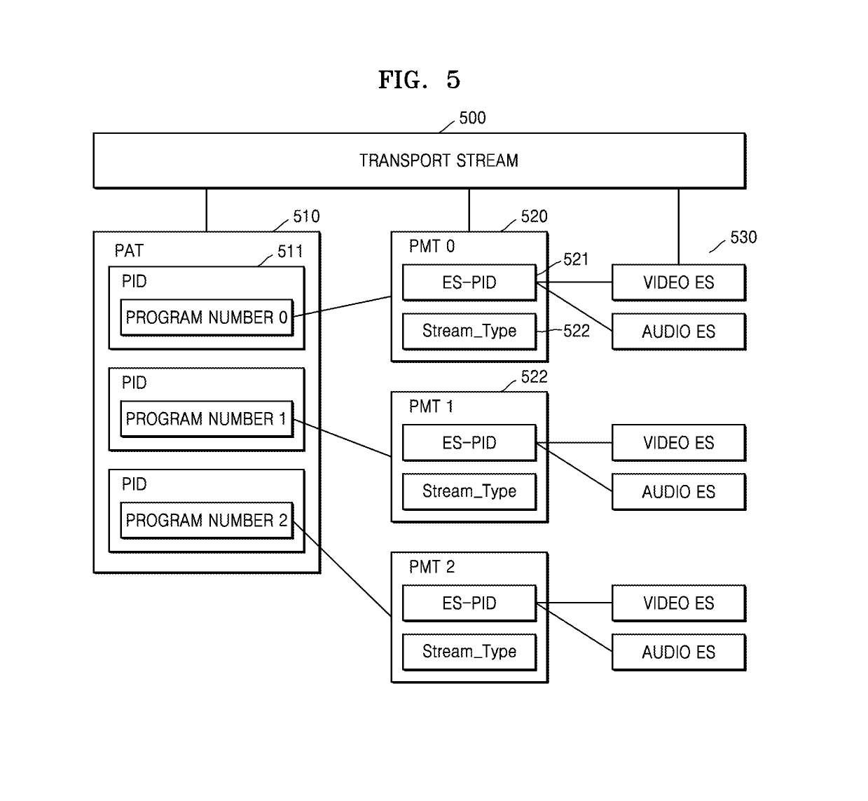

FIG. 5 is a diagram illustrating an example of a transport stream received by the tuner 110 of the electronic device 100.

A Moving Picture Experts Group (MPEG) transport stream (MPEG-TS, MTS, or TS) 500 is a standard format for a transmission and a storage of audio, video, Program and System Information Protocol (PSIP) data. MPEG-TSs are used in broadcast systems such as digital video broadcasting (DVB), advanced television systems committee (ATSC), and Internet protocol TV (IPTV).

The MPEG-TS 500 defines a format encapsulating packetized elementary streams with error correction and stream synchronization features.

A packet is a basic unit of data in a transport stream. A packet includes a sync byte, a header, a payload, and so on. MPEG packets are 188 bytes in length.

Each table or elementary stream in a transport stream is identified by a 13-bit packet identifier (PID). A demultiplexer extracts elementary streams from the transport stream by looking for packets identified by the same PID. A PID may include a value representing a program association table (PAT), a value representing a conditional access table (CAT), a value representing a program map table (PMT), a value representing an elementary stream, and so on.

A transport stream has a concept of programs. One program is described by a PMT having a unique PID and elementary streams associated with programs that have PIDs listed in the PMT. For example, a transport stream used in digital TVs may contain three programs, which represent three TV channels. When each channel is composed of one video stream, one or two audio streams, and necessary metadata, a receiver intending to decode a particular channel decodes the payload of each PID associated with a program of the channel.

A program specific information (PSI) is metadata of a program (channel), and is a part of an MPEG-TS. A PSI is transported in the form of a table. There are four PSI tables: a PAT, a PMT, a CAT, and a network information table (NIT).

A PAT 510 includes information on all programs available in the transport stream. Each listed program is identified by a 16-bit value called a program number. Each program listed in the PAT 510 has a PID 511 for a PMT.

A PMT 520 includes information on a program. There is one PMT for each program. A PMT provides information on each program present in the transport stream 500. Information on a program lists a program number, a PID number 521 of an elementary stream 530 associated with the program, and the elementary stream 530 including an MPEG-2 program. Each elementary stream is labeled with a stream type (stream_type value) 522.

Each elementary stream included in a transport stream is identified by an 8-bit elementary stream type. The elementary stream type indicate a compression format into which a stream corresponding to the program is compressed.

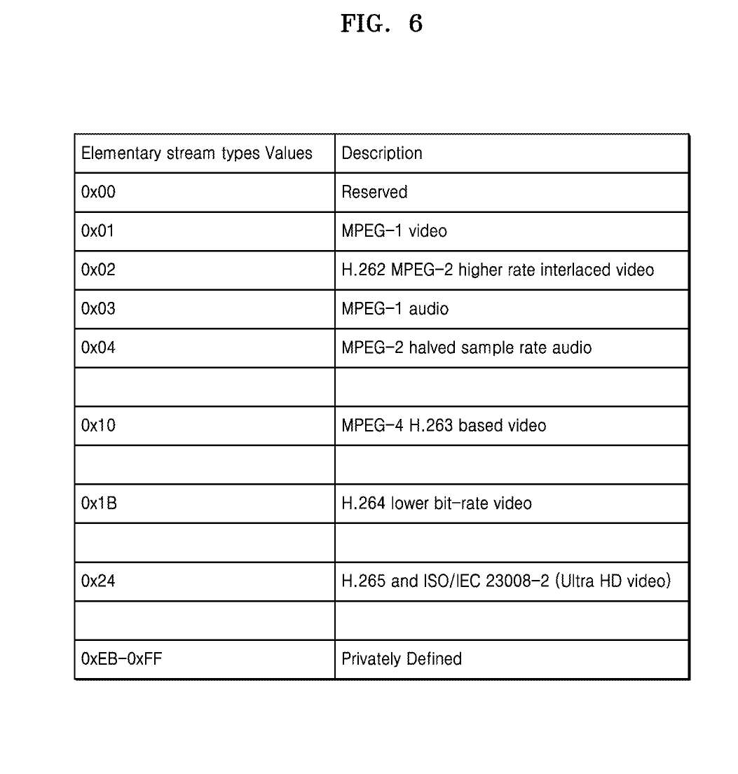

FIG. 6 is a table illustrating an example of an elementary stream type.

Referring to FIG. 6, 0x01 may represent an MPEG-1 video, 0x02 may represent an H.262 MPEG-2 higher rate interlaced video, and 0x24 may represent an H.265 ultra high definition (HD) video.

Ultra-high-definition TV (UHD) is referred to as Super High-Vision, ultra HD TV, UltraHD, and UHDTV, and is a digital video format proposed by NHK science & Technology Research Laboratories and approved by the International Telecommunication Union (ITU).

Standards supporting UHD are H.265/MPEG-H high efficiency video coding (HEVC) and H.264/MPEG-4 advanced video coding (AVC).

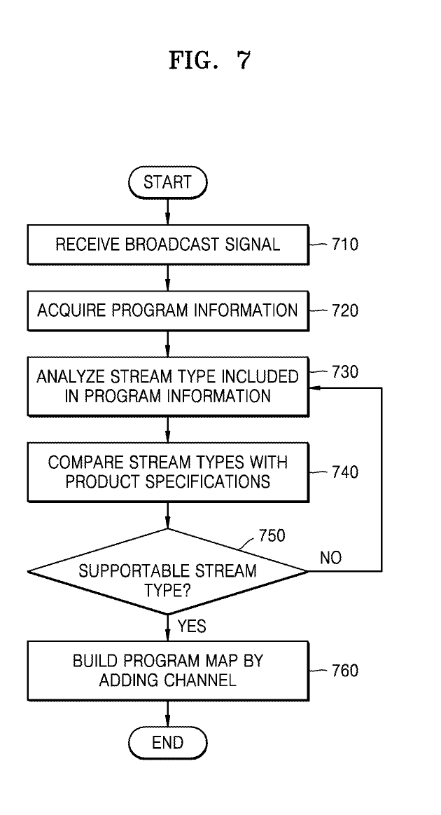

FIG. 7 is a flowchart illustrating an example of an operation performed by the electronic device 100.

Referring to FIG. 7, in operation 710, the tuner 110 of the electronic device 100 receives a broadcast signal. The broadcast signal may be, for example, the transport stream 500 illustrated in FIG. 5.

In operation 720, the demultiplexer 160 of the electronic device 100 extracts program information from the broadcast signal. The demultiplexer 160 may extract the PAT 510 and PMTs 520 from the transport stream 500 illustrated in FIG. 5, and provide the extracted PAT 510 and PMTs 520 to the controller 120. As program information of the broadcast signal, the PAT 510 and the PMTs 520 are just an example, and data in any form may be included as program information of the broadcast signal.

In operation 730, the controller 120 analyzes stream types included in the program information. For example, the controller 120 may be configured to analyze a stream type 522 corresponding to each program from the PAT 510 and the PMTs 520 received from the demultiplexer 160.

In operation 740, the controller 120 compares stream types 522 with product specifications. In other words, the controller 120 is configured to determine whether a stream corresponding to each program is supported by the electronic device 100. For example, the electronic device 100 may store information on the product specifications in the product specification definition DB 153 of the storage 150. As mentioned above, a determination of whether or not a stream is supported by the electronic device 100 may be expressed as a determination of whether or not the stream is processable by the electronic device 100, a determination of whether or not the stream is decodable by the electronic device 100, a determination of whether or not the stream is compatible with the electronic device 100, a determination of whether or not the stream is in accordance with the electronic device 100, and so on. For example, when product specifications of the electronic device 100 supports up to H.264 and a stream corresponding to H.265 is included in a broadcast signal received by the electronic device 100, the controller 120 may be configured to determine that the stream type corresponding to H.265 is not supported by the electronic device 100.

When it is determined in operation 750 that a stream type corresponding to the program is supportable by the electronic device 100, the process proceeds to operation 760, and the controller 120 is configured to build a program map by adding a channel corresponding to the program.

When it is determined that the stream type corresponding to the program is unsupportable or unsupported by the electronic device 100, the process proceeds to operation 730 without adding the channel corresponding to the program, and the controller 120 is configured to analyze a next stream.

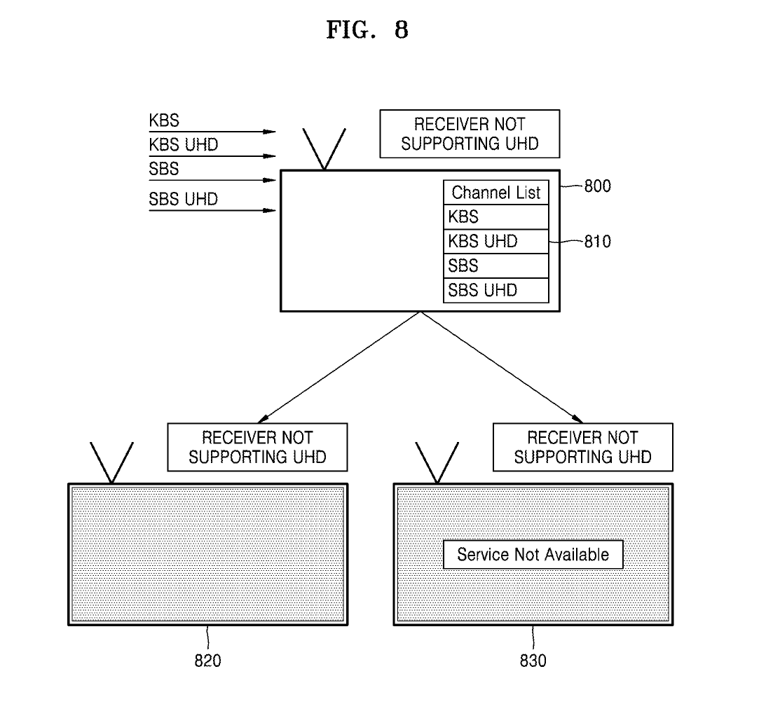

FIG. 8 is a diagram illustrating an example operation of the present disclosure in comparison with an existing operation example.

Referring to FIG. 8, for example, a receiver 800 which does not support UHD receives information on four channels, for example, Korean Broadcasting Station (KBS), KBS UHD, Seoul Broadcasting System (SBS), and SBS UHD. The receiver 800 to which the present disclosure is not applied and which does not support UHD builds a channel map using channel information corresponding to all streams regardless of whether or not each stream is processable by the receiver 800. Therefore, the receiver 800 displays the channel information including all of KBS, KBS UHD, SBS, and SBS UHD as a channel list 810.

Therefore, when the user performs channel zapping or makes a channel selection from the channel list 810 including KBS UHD and SBS UHD, a display of the receiver 800 displays a black screen without any video shown as 820 or displays a message such as “Service Not Available” shown as 830 because the receiver 800 does not support UHD streams. When the number of channels gradually increases, it is considerably tiresome and takes much time for the user to see a screen shown as 820 or 830 of FIG. 8 due to a channel not supported by an electronic device, so that the user may be inconvenienced.

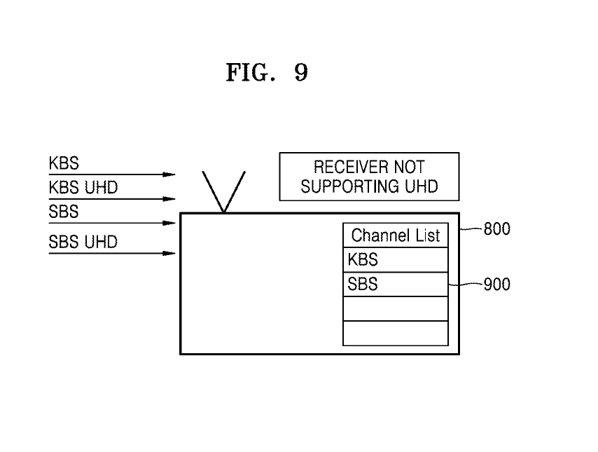

However, according to example embodiments disclosed herein, the receiver 800 not supporting UHD builds a program map excluding a channel having a UHD stream type from a received broadcast signal as described above, and thus the display of the receiver 800 provides only information on programs having stream types processable by the receiver 800. In this way, it is possible to prevent and/or reduce the possibility that the user may unknowingly selecting an unavailable channel. Referring to FIG. 9, the receiver 800 provides only KBS and SBS, which are types supportable by the receiver 800, as channel information 900, and does not provide KBS UHD and SBS UHD which are unsupportable types as channel information.

The term “module” used in various example embodiments of the present disclosure may represent, for example, a unit including a combination of hardware, software, or firmware. The “module” may be may be interchangeably used with a term such as a unit, logic, a logical block, a component, or a circuit. The “module” may be a minimum unit of an integrally configured component or a part thereof. The “module” may be a minimum unit that performs at least one function or a part thereof. The “module” may be mechanically or electronically implemented. For example, the “module” according to various example embodiments of the present disclosure may include one or more of a processor, application-specific integrated circuit (ASIC) chips, field-programmable gate arrays (FPGAs), or programmable-logic devices which are known or are to be developed to perform certain operations.

According to various example embodiments, at least a part of a device (e.g., modules or functions thereof) or method (e.g., operations) according to various example embodiments of the present disclosure may be implemented as instructions stored in computer-readable storage media in the form of programming modules. When the instructions are executed by at least one processor, the at least one processor may perform functions corresponding to the instructions. The computer-readable storage media may be, for example, a memory. At least a part of the programming modules may be implemented (e.g., executed) by the processor. At least a part of the programming modules may include, for example, modules, programs, routines, sets of instructions, or processes to perform at least one function.

The computer-readable storage media may include magnetic media, such as a hard disk, a floppy disk, and a magnetic tape, optical media, such as a CD-ROM and a DVD, magneto-optical media, such as a floptical disk, and hardware devices, such as a ROM, a RAM, and a flash memory, particularly configured to store and execute a program command (e.g., a programming module). The program command may include a high-level language code executed by a computer using an interpreter, etc. as well as a machine language produced by a compiler. The hardware devices may be configured to serve as at least one software module so as to perform operations according to various example embodiments of the present disclosure, or vice versa.

According to the disclosed example embodiments, information on a channel which is not processable by a broadcast receiver is not provided, and thus it is possible to prevent and/or reduce the possibility that a user may unknowingly select the channel and to reduce time wasted in searching for the channel.

It should be understood that example embodiments described herein should be considered in a descriptive sense only and not for purposes of limitation. Descriptions of features or aspects within each example embodiment should typically be considered as available for other similar features or aspects in other example embodiments.

While one or more example embodiments have been described with reference to the figures, it will be understood by those of ordinary skill in the art that various changes in form and details may be made therein without departing from the spirit and scope as defined by the following claims.

What is claimed is:

1. An electronic device comprising:
a receiver configured to receive a broadcast signal; and
a controller configured to:
obtain program information from the broadcast signal, the program information comprising information on a plurality of programs, the information on each program comprising a program identifier and a compression format into which a stream corresponding to the program is compressed;
determine whether the compression format of the program is processable by the electronic device; and
generate a program map including the program identifier corresponding to the program having the compression format being processable by the electronic device, and excluding the program identifier corresponding the program having the compression format not being processable by the electronic device.

2. The electronic device of claim 1, further comprising a display, and
wherein the controller controls the display to display the generated program map.

3. A method for operating an electronic device comprising:
receiving a broadcast signal;
obtaining program information from the broadcast signal, the program information comprising information on a plurality of programs, the information on each program comprising a program identifier and a compression format into which a stream corresponding to the program is compressed;
determining whether the compression format of the program is processable by the electronic device; and
generating a program map including the program identifier corresponding to the program having the compression format being processable by the electronic device, and excluding the program identifier corresponding the program having the compression format not being processable by the electronic device.

4. The operating method of claim 3, further comprising:
displaying the generated program map on a display.

5. A non-transitory computer-readable recording medium storing a program which, when executed by a processor causes an electronic device to perform the operations recited in claim 3.
